(19) United States
(12) Patent Application Publication
(10) Pub. No.: US 2025/0045446 A1
(43) Pub. Date: Feb. 6, 2025

(54) SIMILARITY HASHING FOR ACCESS CONTROL

(71) Applicant: EQUIFAX INC., Atlanta, GA (US)

(72) Inventor: Nathan Daniel MONNIG, Boise, ID (US)

(21) Appl. No.: 18/365,781

(22) Filed: Aug. 4, 2023

(51) Int. Cl. G06F 21/62; G06F 21/60; H04L 9/32

(52) U.S. Cl. CPC G06F 21/6227; G06F 21/604; H04L 9/3236; G06F 2221/2141

(57) ABSTRACT

A system can efficiently control access to an interactive computing environment using similarity hashing. The system can receive a first similarity-preserving hash based on an interaction request associated with a target entity for requesting access to an interactive computing environment. The system can receive a second similarity-preserving hash based on entity data relating to an entity and including interaction data. The system can determine, based on a comparison between the first similarity-preserving hash and the second similarity-preserving hash, a likelihood that the interaction request is legitimate. The system can provide a responsive message based on a threshold relating to the likelihood, the responsive message usable to control access to the interactive computing environment.

### TECHNICAL FIELD

The present disclosure relates generally to risk assessment and access control. More specifically, but not by way of limitation, this disclosure relates to controlling access to an interactive computing environment using similarity hashing.

### BACKGROUND

Various interactions are performed frequently through an interactive computing environment such as a website, a user interface, etc. Controlling access to the interactive computing environment is important to the security and performance of the system. Access to the environment can be controlled through conventional means such as a username/password combination, multi-factor authentication, and the like. But the conventional means may not consider other factors about an entity that may affect a risk associated with granting the entity access to the interactive computing environment.

### SUMMARY

Various aspects of the present disclosure provide systems and methods for controlling access of a computing device to an interactive computing environment using similarity hashing. The system can include a processor and a non-transitory computer-readable medium that includes instructions that are executable by the processor to cause the processor to perform various operations. The system can receive, based on an interaction request submitted by a target entity, a first similarity-preserving hash, the interaction request including a request to access an interactive computing environment. The system can receive a second similarity-preserving hash that can be generated based on entity data relating to an entity. The entity data can include interaction data that indicates a manner in which the entity historically interacted with webpages. The system can determine, based on a comparison between the first similarity-preserving hash and the second similarity-preserving hash, a likelihood that the interaction request is legitimate. The system can provide a responsive message based on a threshold relating to the likelihood. The responsive message can be used to control access to the interactive computing environment.

In other aspects, a method can efficiently control access to an interactive computing environment using similarity hashing. The method can include receiving, by a computing device and based on an interaction request submitted by a target entity, a first similarity-preserving hash. The interaction request can include a request to access an interactive computing environment. The method can include receiving, by the computing device, a second similarity-preserving hash generated based on entity data relating to an entity. The entity data can include interaction data that indicates a manner in which the entity historically interacted with webpages. The method can include determining, by the computing device and based on a comparison between the first similarity-preserving hash and the second similarity-preserving hash, a likelihood that the interaction request is legitimate. The method can include providing, by the computing device, a responsive message based on a threshold relating to the likelihood. The responsive message can be used to control access to the interactive computing environment.

In other aspects, a non-transitory computer-readable medium can include instructions that are executable by a processing device for causing the processing device to perform various operations. The operations can include receiving, based on an interaction request submitted by a target entity, a first similarity-preserving hash. The interaction request can include a request to access an interactive computing environment. The operations can include receiving a second similarity-preserving hash that can be generated based on entity data relating to an entity. The entity data can include interaction data that indicates a manner in which the entity historically interacted with webpages. The operations can include determining, based on a comparison between the first similarity-preserving hash and the second similarity-preserving hash, a likelihood that the interaction request is legitimate. The operations can include providing a responsive message based on a threshold relating to the likelihood. The responsive message can be used to control access to the interactive computing environment.

This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

The foregoing, together with other features and examples, will become more apparent upon referring to the following specification, claims, and accompanying drawings.

### BRIEF DESCRIPTION OF DRAWINGS

FIG. 1 is a block diagram depicting an example of a computing environment in which access to an interactive computing environment can be controlled using similarity hashing according to certain aspects of the present disclosure.

FIG. 2 is a flowchart depicting an example of a process for using similarity hashing to control access to an interactive computing environment according to certain aspects of the present disclosure.

FIG. 3 is a flowchart depicting an example of a process for determining a risk assessment indicator using similarity hashing according to certain aspects of the present disclosure.

FIG. 4 is a block diagram illustrating a data flow for controlling access to an interactive computing environment using similarity hashing according to certain aspects of the present disclosure.

FIG. 5 is a block diagram depicting an example of a computing system suitable for implementing aspects of the techniques and technologies presented herein.

### DETAILED DESCRIPTION

Controlling access to an interactive computing environment properly can improve the security of the interactive computing environment. For example, requiring a username/password combination, multi-factor authentication, biometric authentication, and the like can provide security for sensitive accounts or data included in the interactive computing environment. But these techniques may not involve or otherwise consider whether the entity attempting to access the interactive computing environment is associated with increased security or malicious action risk.

Additionally, when low-fidelity data is used to control access to an interactive environment, conventional hashing algorithms cannot be used for authentication. This is because conventional hashing algorithms are used to check for an exact match. As such, conventional hashing algorithms cannot be used to check for similarity, for example, between low-fidelity data received from a user and low-fidelity data stored at an authentication system. Accordingly, systems using conventional hashing algorithms cannot use low-fidelity data for authentication as the low-fidelity data collected at the time of authentication may not be an exact match against stored low-fidelity data.

Certain aspects described herein for controlling access to the interactive computing environment using similarity hashing can address one or more issues identified above. For example, similarity hashing can involve encrypting one or more biometric data features relating to interactions (e.g., historical interactions, real-time interactions, etc.) of an entity. Similarity-preserving hashes can be used to determine whether to grant access to the interactive computing environment to a target entity that may have submitted a request to access the interactive computing environment. The target entity can include a user, such as an individual, or other suitable type of entity. A similarity-preserving hash can be or include a one-way encrypted feature vector that cannot be decrypted. For example, the similarity-preserving hash can be one-way encrypted using techniques such as randomized projections, trend micro locality sensitive hashing, and the like. Although reference is made herein to similarity preserving hashing algorithms, other hashing algorithms, such as locality preserving hashing algorithms can be used.

In some examples, a similarity-preserving hash can be or include a feature vector determined based on data gathered or otherwise received about a target entity that submitted a request to access an interactive computing environment. The data may include biometric data, low-fidelity data, and the like. For example, the data (e.g., the low-fidelity data) may include cursor movements made by the target entity, a screen orientation of a device used by the target entity, time spent on a particular webpage by the target entity, keystrokes of the target entity, and the like. The data may be or include identity data related to the target entity but may exclude identity data unique to the target entity. For example, the data may include protected data classes, prohibited data, and the like that may imply that the target entity may experience a particular medical condition, but the data alone may not be able to be used to identify the target entity. Using the data to generate the similarity-preserving hash may allow requests for accessing the interactive computing environment to be compared (e.g., among one another, to other access attempts, etc.) without identifying the target entity, without disclosing confidential or protected information, or the like.

The interactive computing environment can be provided by a client computing system. For example, the client computing system can be, or may be controlled by, an entity that may provide software as a service, infrastructure as a service, and other suitable services accessible by a user computing system that can be used by the target entity. In some examples, the interactive computing environment can include a user interface. The target entity can use the user computing system to request access to a particular user interface that can be used to request services or other suitable computing resources from the client computing system. For example, the target entity can request a credit line, cloud computing storage resources, or any other suitable services or computing resources from the client computing system via the interactive computing environment. In other examples, the interactive computing environment can include one or more websites or sub-pages thereof. For example, the interactive computing environment can include a secure website provided by the client computing system. The secure website can include cloud computing storage or other resources, and the client computing system can control access of the target entity to the secure website via the entity profile and, optionally, other suitable security techniques such as multi-factor authentication, username/password combinations, etc.

In some examples, similarity hashing can be used for other suitable purposes in addition to, or alternative to, controlling access to the interactive computing environment. For example, the similarity hashing can be used to verify an identity of the target entity, to determine whether to provide real-world goods and/or services on behalf of the target entity or other entities, and the like. The similarity hashing can involve comparing two or more similarity-preserving hashes to determine, for example with respect to an online or real-world interaction, a likelihood that the target entity has provided a genuine identity. In another example, a client, such as a provider of restricted or regulated goods or services, can use the similarity hashing to determine whether to provide the restricted or regulated goods or services to the target entity. In some examples, the similarity hashing can be used for digital enablement of an interaction with respect to the target entity without positively identifying the target entity.

In a particular example, the target entity may successfully log into the interactive computing environment. Data, such as the low-fidelity data, etc., about the entity may be continuously or periodically monitored to determine whether the target entity is still successfully logged in or whether a malicious actor has gained access to the interactive computing environment such as on behalf of the target entity. In some examples, a hash based on the data may eventually not correspond to the stored hash for the target entity. In such examples, the computing system may suspend access to the interactive computing environment or take other suitable corrective action or preventative action.

Certain aspects described herein, which can include generating one or more similarity-preserving hashes, comparing two or more similarity-preserving hashes, and controlling access to the interactive computing environment based on the one or more similarity-preserving hashes, can improve the technical field of access control for a computing environment. For instance, by using the one or more similarity-preserving hashes, a risk assessment computing system may provide legitimate access to the interactive computing environment using fewer computing resources compared to other risk assessment systems or techniques. For example, the one or more similarity-preserving hashes can be determined using less data about the target entity than other techniques, which may rely on identifying data such as fingerprints, facial scans, and the like. By using less data, (i) memory usage, (ii) processing time, (iii) network bandwidth usage, (iv) response time, and the like for controlling access to the interactive computing environment is reduced, and functioning of a computing device is improved. Additionally, similarity-preserving hashes can be used to control access to a resource based on data that may vary over time or between authentication attempts. Accordingly, the risk assessment computing system improves the access control for computing environment by reducing memory usage, processing time, network bandwidth consumption, response time, and the like with respect to controlling access to the interactive computing environment using similarity hashing.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative examples but, like the illustrative examples, should not be used to limit the present disclosure.

### Operating Environment Example for Controlling Access to a Computing Environment

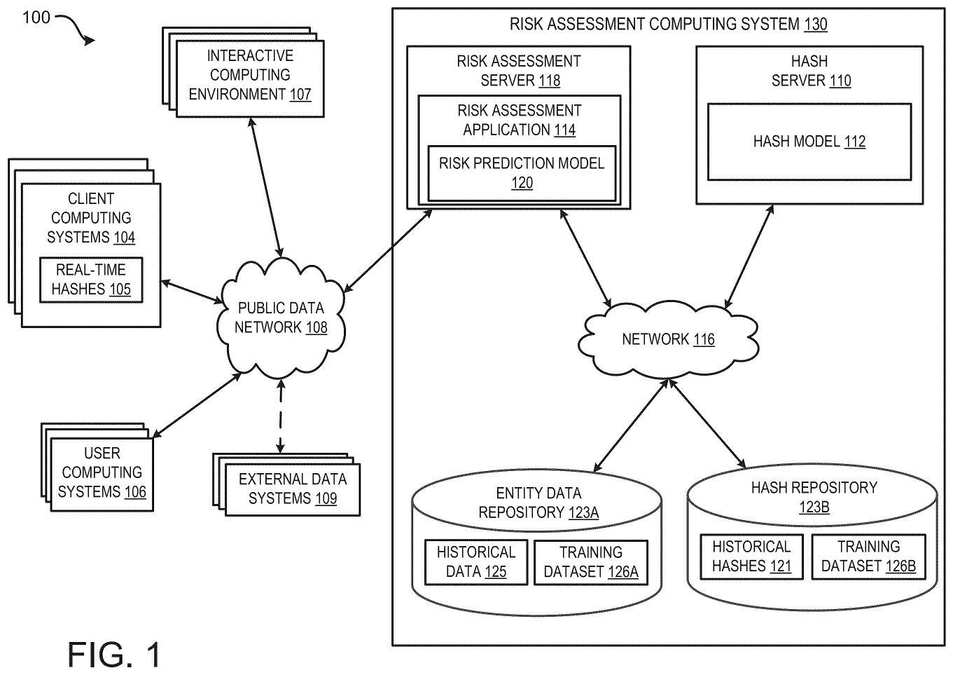

Referring now to the drawings, FIG. 1 is a block diagram depicting an example of a computing environment 100 in which access to an interactive computing environment 107 can be controlled using similarity hashing according to certain aspects of the present disclosure. FIG. 1 depicts examples of hardware components of a risk assessment computing system 130, according to some aspects. The risk assessment computing system 130 can be a specialized computing system that may be used for processing large amounts of data, such as for controlling access to the interactive computing environment 107, etc., using a large number of computer processing cycles. The risk assessment computing system 130 can include a risk assessment server 118 for validating risk assessment data from various sources. In some examples, the risk assessment computing system 130 can include other suitable components, servers, subsystems, and the like.

The risk assessment server 118 can include one or more processing devices that can execute program code, such as a risk assessment application 114, a risk prediction model 120, and the like. The program code can be stored on a non-transitory computer-readable medium or other suitable medium. The risk assessment server 118 can perform risk assessment validation operations or access control operations for validating or otherwise authenticating, for example using other suitable modules, models, components, etc. of the risk assessment server 118, received data such as authentication data, similarity-preserving hashes (e.g., real-time hashes 105, historical hashes 121, etc.), and the like received from the user computing systems 106, client computing systems 104, one or more data repositories, or any suitable combination thereof. In some aspects, the risk assessment application 114 can authenticate the request by utilizing the real-time hashes 105, the historical hashes 121, historical data 125, any combination thereof, or any information determined therefrom.

The historical hashes 121, the real-time hashes 105, or a combination thereof can be determined based on low-fidelity data, biometric data, or the like, which may be stored as historical data 125. Additionally, the historical data 125 may include interaction data that indicates a manner in which the entity historically interacted with webpages. The historical hashes 121, the historical data 125, or a combination thereof can be determined and stored in one or more network-attached storage units on which various repositories, databases, or other structures are stored. Examples of these data structures can include the entity data repository 123a, and the hash repository 123b. Additionally or alternatively, a training dataset 126a can be stored in the entity data repository 123a, and a training dataset 126b can be stored in the hash repository 123b. In some examples, the training datasets 126a-b can be used to train one or more machine-learning models, which may include the risk assessment application 114, a hash model 112, and the like. The one or more machine-learning models can be trained to determine similarity-preserving hashes, to compare the similarity-preserving hashes, to control access to the interactive computing environment 107 using the similarity-preserving hashes or any comparison thereof, or to otherwise provide digital enablement for the target entity.

Network-attached storage units may store a variety of different types of data organized in a variety of different ways and from a variety of different sources. For example, the network-attached storage unit may include storage other than primary storage located within the risk assessment server 118 that is directly accessible by processors located therein. In some aspects, the network-attached storage unit may include secondary, tertiary, or auxiliary storage, such as large hard drives, servers, and virtual memory, among other types of suitable storage. Storage devices may include portable or non-portable storage devices, optical storage devices, and various other mediums capable of storing and containing data. A machine-readable storage medium or computer-readable storage medium may include a non-transitory medium in which data can be stored and that does not include carrier waves or transitory electronic signals. Examples of a non-transitory medium may include, for example, a magnetic disk or tape, optical storage media such as a compact disk or digital versatile disk, flash memory, memory devices, or other suitable media.

Furthermore, the risk assessment computing system 130 can communicate with various other computing systems. The other computing systems can include user computing systems 106, such as smartphones, personal computers, etc., client computing systems 104, and other suitable computing systems. For example, user computing systems 106 may send, for example in response to receiving input from the target entity, requests for accessing the interactive computing environment 107 to the client computing systems 104. In response, the client computing systems 104 can send authentication queries to the risk assessment server 118, and the risk assessment server 118 can receive entity data about the target entity for generating similarity-preserving hashes, comparing similarity-preserving hashes, or a combination thereof. While FIG. 1 illustrates that the risk assessment computing system 130 and the client computing systems 104 are separate systems, the risk assessment computing system 130 and the client computing systems 104 can be one system. For example, the risk assessment computing system 130 can be a part of the client computing systems 104, or vice versa.

As illustrated in FIG. 1, the risk assessment computing system 130 may interact with the client computing systems 104, the user computing systems 106, or a combination thereof via one or more public data networks 108 to facilitate interactions between users of the user computing systems 106 and the interactive computing environment 107. For example, the risk assessment computing system 130 can facilitate the client computing systems 104 providing a user interface to the user computing system 106 for receiving various data from the user. The risk assessment computing system 130 can transmit validated risk assessment data, for example similarity-preserving hashes, comparisons or scores determined therefrom, etc., to the client computing systems 104 for providing, challenging, or rejecting, etc. access of the target entity to the interactive computing environment 107. In some examples, the risk assessment computing system 130 can additionally (e.g., optionally) communicate with third-party systems, such as external data systems 109 to receive additional risk assessment or entity data, etc., through the public data network 108. For example, the third-party systems can provide real-time (e.g., streamed) data about the target entity, historical data about the target entity, etc. to the risk assessment computing system 130.

Each client computing system 104 may include one or more devices such as individual servers or groups of servers operating in a distributed manner. A client computing system 104 can include any computing device or group of computing devices operated by a seller, lender, or other suitable entity that can provide products or services. The client computing system 104 can include one or more server devices. The one or more server devices can include or can otherwise access one or more non-transitory computer-readable media.

The client computing system 104 can further include one or more processing devices that can be capable of providing an interactive computing environment 107, such as a user interface, etc., that can perform various operations. The interactive computing environment 107 can include executable instructions stored in one or more non-transitory computer-readable media. The instructions providing the interactive computing environment can configure one or more processing devices to perform the various operations. In some aspects, the executable instructions for the interactive computing environment can include instructions that provide one or more graphical interfaces. The graphical interfaces can be used by a user computing system 106 to access various functions of the interactive computing environment 107. For instance, the interactive computing environment 107 may transmit data to and receive data (e.g., via the graphical interface) from a user computing system 106 to shift between different states of the interactive computing environment 107, where the different states allow one or more electronic interactions between the user computing system 106 and the client computing system 104 to be performed.

In some examples, the client computing system 104 may include other computing resources associated therewith (e.g., not shown in FIG. 1), such as server computers hosting and managing virtual machine instances for providing cloud computing services, server computers hosting and managing online storage resources for users, server computers for providing database services, and others. The interaction between the user computing system 106, the client computing system 104, and the risk assessment computing system 130, or any suitable sub-combination thereof may be performed through graphical user interfaces, such as the user interface, presented by the risk assessment computing system 130, the client computing system 104, other suitable computing systems of the computing environment 100, or any suitable combination thereof. The graphical user interfaces can be presented to the user computing system 106. Application programming interface (API) calls, web service calls, or other suitable techniques can be used to facilitate interaction between any suitable combination or sub-combination of the client computing system 104, the user computing system 106, and the risk assessment computing system 130.

A user computing system 106 can include any computing device or other communication device operated by a user or entity, such as the target entity, which may include a consumer or a customer. The user computing system 106 can include one or more computing devices such as laptops, smartphones, and other personal computing devices. A user computing system 106 can include executable instructions stored in one or more non-transitory computer-readable media. The user computing system 106 can additionally include one or more processing devices configured to execute program code to perform various operations. In various examples, the user computing system 106 can allow a user to access certain online services or other suitable products, services, or computing resources from a client computing system 104, to engage in mobile commerce with the client computing system 104, to obtain controlled access to electronic content, such as the interactive computing environment 107, hosted by the client computing system 104, etc.

In some examples, the target entity can use the user computing system 106 to engage in an electronic interaction with the client computing system 104 via the interactive computing environment 107. The risk assessment computing system 130 can receive a request, for example from the user computing system 106, to access the interactive computing environment 107 and can use data, such as the real-time hashes 105, the historical hashes 121, or any suitable comparisons or scores determined therefrom, to determine whether to provide access, to challenge the request, to deny the request, etc. An electronic interaction between the user computing system 106 and the client computing system 104 can include, for example, the user computing system 106 being used to request a financial loan or other suitable services or products from the client computing system 104, and so on. An electronic interaction between the user computing system 106 and the client computing system 104 can also include, for example, one or more queries for a set of sensitive or otherwise controlled data, accessing online financial services provided via the interactive computing environment 107, submitting an online credit card application or other digital application to the client computing system 104 via the interactive computing environment 107, operating an electronic tool within the interactive computing environment 107 (e.g., a content-modification feature, an application-processing feature, etc.), etc.

In some aspects, an interactive computing environment 107 implemented through the client computing system 104 can be used to provide access to various online functions. As a simplified example, a user interface or other interactive computing environment 107 provided by the client computing system 104 can include electronic functions for requesting computing resources, online storage resources, network resources, database resources, or other types of resources. In another example, a website or other interactive computing environment 107 provided by the client computing system 104 can include electronic functions for obtaining one or more financial services, such as an asset report, management tools, credit card application and transaction management workflows, electronic fund transfers, etc.

A user computing system 106 can be used to request access to the interactive computing environment 107 provided by the client computing system 104. The client computing system 104 can submit a request (e.g., in response to a request made by the user computing system 106 to access the interactive computing environment 107) for risk assessment to the risk assessment computing system 130 and can selectively grant or deny access to various electronic functions based on risk assessment performed by the risk assessment computing system 130. Based on the request, the risk assessment computing system 130 can determine one or more similarity-preserving hashes for a target entity that submitted the request via the user computing system 106. Based on a comparison between the one or more similarity-preserving hashes (e.g., the real-time hashes 105) and the historical hashes 121, the risk assessment computing system 130, the client computing system 104, or a combination thereof can determine whether to grant the access request of the user computing system 106 to certain features of the interactive computing environment 107.

In a simplified example, the system depicted in FIG. 1 can configure the risk assessment server 118 to be used for controlling access to the interactive computing environment 107. The risk assessment server 118 can receive data about a target entity that submitted a request to access the interactive computing environment 107, for example, based on the information (e.g., information collected by the client computing system 104 via a user interface provided to the user computing system 106) provided by the client computing system 104 or received via other suitable computing systems. The risk assessment server 118 can receive, for example from the hash server 110, the one or more similarity-preserving hashes for the target entity such that the one or more similarity-preserving hashes are based on the received data about the target entity. The risk assessment server 118 can determine one or more scores for the target entity based on comparisons between the one or more similarity-preserving hashes (e.g., the real-time hashes 105) and the historical hashes 121. The risk assessment server 118 can transmit the one or more scores, the one or more similarity hashes, or a combination thereof to the client computing system 104 for use in controlling access to the interactive computing environment 107.

In some examples, the one or more similarity-preserving hashes, or any suitable score or comparison determined therefrom, can be utilized (e.g., by the risk assessment computing system 130, the client computing system 104, etc.) to determine whether the risk associated with the target entity accessing a good or a service provided by the client computing system 104 exceeds a threshold, thereby granting, challenging, or denying access by the target entity to the interactive computing environment 107. For example, if the risk assessment computing system 130 determines that the one or more similarity hashes or associated comparisons or scores indicate that risk of the target entity is lower than a threshold value, then the client computing system 104 associated with the service provider can generate or otherwise provide access permission to the user computing system 106 that requested the access. The access permission can include, for example, cryptographic keys used to generate valid access credentials or decryption keys used to decrypt access credentials. The client computing system 104 can also allocate resources to the target entity and provide a dedicated web address for the allocated resources to the user computing system 106, for example, by adding the user computing system 106 in the access permission. With the obtained access credentials or the dedicated web address, the user computing system 106 can establish a secure network connection to the interactive computing environment 107 hosted by the client computing system 104 and access the resources via invoking API calls, web service calls, HTTP requests, other suitable mechanisms or techniques, etc.

In some examples, the risk assessment computing system 130 may determine whether to grant, challenge, or deny the access request made by the user computing system 106 for accessing the interactive computing environment 107. For example, based on the one or more similarity-preserving hashes or associated comparisons or scores, the risk assessment computing system 130 can determine that the target entity is a legitimate entity that made the access request and may authenticate the request. In other examples, the risk assessment computing system 130 can challenge or deny the access attempt if the risk assessment computing system 130 determines that the target entity may not be a legitimate entity.

Each communication within the computing environment 100 may occur over one or more data networks, such as a public data network 108, a network 116 such as a private data network, or some combination thereof. A data network may include one or more of a variety of different types of networks, including a wireless network, a wired network, or a combination of a wired and wireless network. Examples of suitable networks include the Internet, a personal area network, a local area network (“LAN”), a wide area network (“WAN”), or a wireless local area network (“WLAN”). A wireless network may include a wireless interface or a combination of wireless interfaces. A wired network may include a wired interface. The wired or wireless networks may be implemented using routers, access points, bridges, gateways, or the like, to connect devices in the data network.

The number of devices depicted in FIG. 1 is provided for illustrative purposes. Different numbers of devices may be used. For example, while certain devices or systems are shown as single devices in FIG. 1, multiple devices may instead be used to implement these devices or systems. Similarly, devices or systems that are shown as separate, such as the risk assessment server 118 and the entity data repository 123a, etc., may be instead implemented in a single device or system. Similarly and as discussed above, the risk assessment computing system 130 may be a part of the client computing system 104.

### Techniques for Generating an Entity Profile for a Target Entity

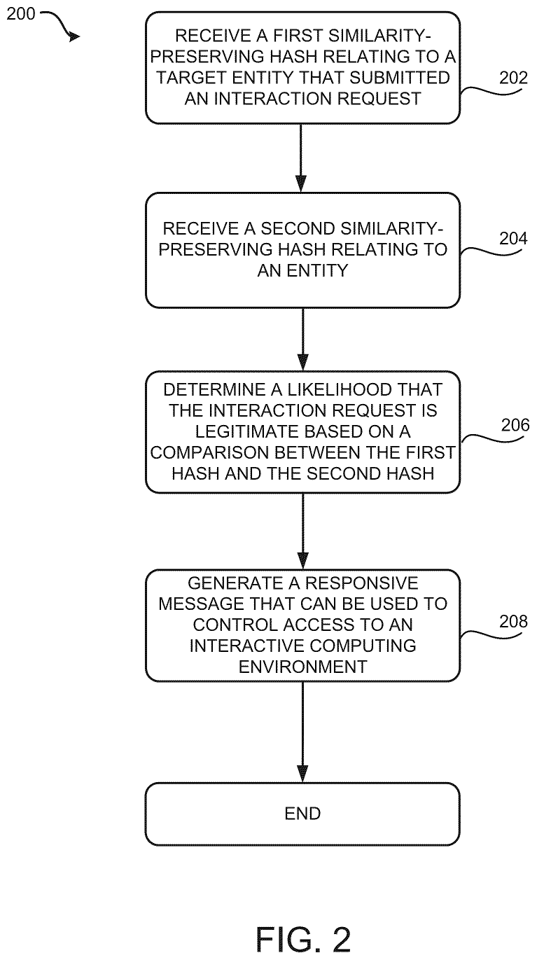

FIG. 2 is a flow chart depicting an example of a process 200 for using similarity hashing to control access to an interactive computing environment 107 according to certain aspects of the present disclosure. One or more computing devices, such as the risk assessment computing system 130, may implement operations illustrated in FIG. 2 by executing suitable program code such as the hash model 112, the risk prediction model 120, or the like. For illustrative purposes, the process 200 is described with reference to certain examples depicted in the figures. Other implementations, however, are possible.

At block 202, the process 200 involves receiving a first similarity-preserving hash relating to an entity, such as the target entity, that submitted an interaction request. The interaction request may include a request to access an interactive computing environment such as the interactive computing environment 107. The target entity may use the user computing systems 106 to submit the request. For example, the target entity may input authentication information, or any other suitable information, into the user computing systems 106, for example via a user interface provided by the client computing systems 104, into the user computing systems 106 to request access to the interactive computing environment 107.

In some examples, the client computing systems 104, the user computing systems 106, or a combination thereof may gather data relating to the target entity interacting with the user interface to generate or submit the request for access. The data may be or include low-fidelity data, biometric data, other suitable data, and the like. For example, the data may include cursor movement of the target entity, a screen orientation of a user device used by the target entity, keystrokes made by the target entity, time spent on the user interface or other webpages by the target entity, and the like. The client computing systems 104, the user computing systems 106, or a combination thereof may transmit the data gathered about the target entity to the risk assessment computing system 130 for generating the first similarity-preserving hash, for example using the hash model 112.

In some examples, the risk assessment computing system 130, or other suitable computing systems, may transmit a software package or other forms of computer-executable instructions, to the client computing systems 104, to the user computing systems 106, or to a combination thereof. The client computing systems 104, the user computing systems 106, or a combination thereof may use the software package or other forms of computer-executable instructions to generate the first similarity-preserving hash. For example, the client computing systems 104, the user computing systems 106, or a combination thereof may gather the data about the target entity and may use the data about the target entity to generate the first similarity-preserving hash. The client computing systems 104, the user computing systems 106, or a combination thereof may encrypt the data about the target entity. For example, the client computing systems 104, the user computing systems 106, or a combination thereof may use techniques, such as randomized projections, trend micro locality sensitive hashing, and the like, to one-way encrypt the data about the target entity to generate the first similarity-preserving hash. By one-way encrypting the data about the target entity to generate the first similarity-preserving hash, the first similarity-preserving hash may be secure from attempts to decrypt the underlying data. In some examples, a minimum amount of collected data can be used to generate an accurate baseline or comparison hash. Additionally or alternatively, the low-fidelity data may be collected from components, such as a touchscreen, an accelerometer, etc., of a user device such as a mobile phone.

At block 204, the process 200 involves receiving a second similarity-preserving hash relating to an entity. The entity may be different than the target entity, or the entity may be the target entity. In some examples, the risk assessment computing system 130 may access one or more data repositories to receive the second similarity-preserving hash. The one or more data repositories may include the entity data repository 123a, the hash repository 123b, or any other suitable data repositories. The risk assessment computing system 130 may access the entity data repository 123a to receive historical data 125 about the entity. The historical data 125 about the entity may include interaction data that indicates a manner in which the entity historically interacted with webpages. The risk assessment computing system 130 may use the historical data 125 to generate the second similarity-preserving hash relating to the entity. For example, the historical data 125 may include historical keystrokes, clicks, cursor movements, device orientations, time spent on webpages, and the like for the entity, and the risk assessment computing system 130 may one-way encrypt the historical data 125 to generate the second similarity-preserving hash. In other examples, the second similarity-preserving hash may have previously been generated and stored in the hash repository 123b, included in the historical hashes 121. The risk assessment computing system 130 may access the hash repository 123b to receive the second similarity-preserving hash and any other suitable hashes included in the historical hashes 121. Additionally or alternatively, the first similarity-preserving hash, the second similarity-preserving hash, or a combination thereof may include more than one (e.g., two, three, four, etc.) similarity-preserving hash.

At block 206, the process 200 involves determining a likelihood that the request is legitimate based on a comparison between the first similarity-preserving hash and the second similarity-preserving hash. The risk assessment computing system 130, or any component or model (e.g., the risk prediction model 120) thereof, can compare the first similarity-preserving hash with the second similarity-preserving hash. In some examples, comparing the hashes may involve comparing individual values of the respective hashes, comparing a combination of values of the respective hashes, and the like. For example, the risk assessment computing system 130 can compare values of a first feature vector associated with the first similarity-preserving hash with values of a second feature vector associated with the second similarity-preserving hash. Based on the foregoing comparison, the risk assessment computing system 130 can determine a similarity score between the first similarity-preserving hash and the second similarity-preserving hash.

In some examples, the risk prediction model 120, or any other suitable component of the risk assessment computing system 130 or the risk assessment computing system 130 itself, may perform one or more operations to determine whether the request submitted by the target entity is likely to be legitimate. The risk prediction model 120 may apply a threshold to the similarity score determined for the first similarity-preserving hash and the second similarity-preserving hash to determine a likelihood that the request submitted by the target entity is legitimate. For example, if the similarity score exceeds the threshold, the risk assessment computing system 130 may determine that the target entity is likely to be the entity and that the request submitted by the target entity is likely to be legitimate. Additionally or alternatively, if the similarity score does not exceed the threshold, the risk assessment computing system 130 may determine that the target entity is likely not the entity and that the request submitted by the target entity is likely to not be legitimate. In some examples, the threshold may enable the risk assessment computing system 130, or any component or subset thereof, to account for minor variations in the low-fidelity data. Additionally or alternatively, the threshold may be tuned based at least in part on a desired level of security for the interactive computing environment 107.

At block 208, the process 200 involves generating a responsive message that can be used to control access to the interactive computing environment 107. In some examples, the risk assessment server 118 (or any other suitable module, model, or computing device) can transmit the responsive message to a computing device (e.g., the client computing system 104) or any other suitable computing device that can control access to the interactive computing environment 107. The responsive message can vary based on the comparison between the first similarity-preserving hash and the second similarity-preserving hash. For example, the responsive message may indicate that the target entity submitting the access request is the legitimate entity and may recommend granting access to the interactive computing environment 107 based on the request. In other examples, the responsive message may indicate that the entity is unknown or otherwise not associated with legitimate activity and may recommend challenging or denying the request.

In some examples, the responsive message may be generated and transmitted based on the comparison between the first similarity-preserving hash and the second similarity-preserving hash. For example, the risk prediction model 120 can generate one or more risk indicators for the target entity based on the comparison, and the risk assessment server 118 can generate the responsive message based on the one or more risk indicators. The one or more risk indicators can include a credit score, a fraud score, an identity score, other suitable scores indicating risk in one or more multiple dimensions associated with the target entity, or any suitable combination thereof, based on the comparison. The risk prediction model 120 can generate the risk indicator based on the feature vectors associated with the first similarity-preserving hash and the second similarity-preserving hash, can generate the risk indicator based on the comparison, and the like. The risk assessment server 118 can determine, based on the one or more risk indicators generated by the risk prediction model 120, whether to recommend granting, challenging, or denying the request submitted by the target entity. In some examples, the risk assessment computing system 130 can generate and transmit the responsive message to grant, challenge, or deny the request based on a recommendation provided by the risk prediction model 120.

### Techniques for Controlling Access to a Computing Environment Using an Entity Profile

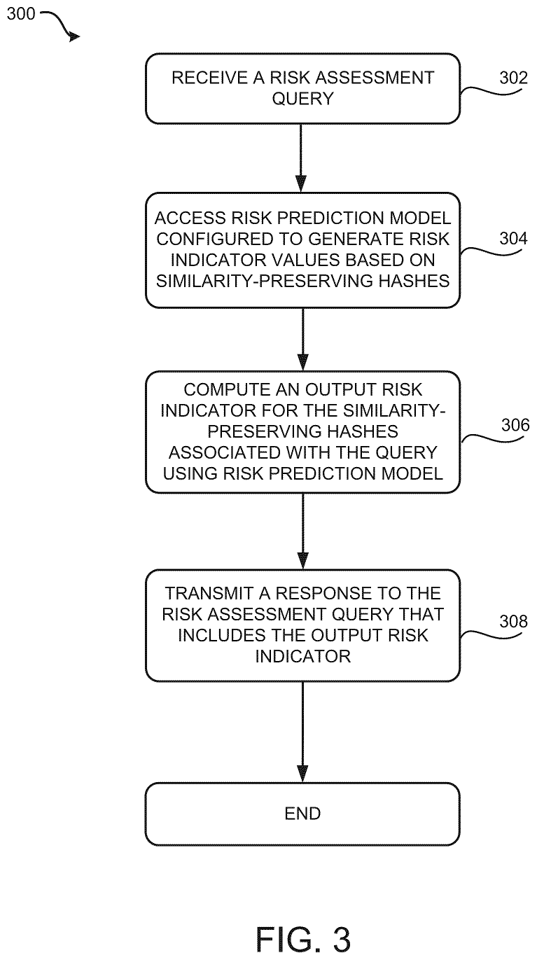

FIG. 3 is a flow chart depicting an example of a process 300 for controlling access to an interactive computing environment 107 using similarity hashing according to certain aspects of the present disclosure. One or more computing devices, such as the risk assessment computing system 130, may implement operations illustrated in FIG. 3 by executing suitable program code such as the hash model 112, the risk prediction model 120, and the like. For illustrative purposes, the process 300 is described with reference to certain examples depicted in the figures. Other implementations, however, are possible.

At block 302, the process 300 involves receiving a risk assessment query for a target entity from a remote computing device, such as a computing device associated with the target entity requesting the risk assessment. The risk assessment query can also be received by the risk assessment server 118 from a remote computing device associated with an entity authorized to request risk assessment of the target entity.

At block 304, the process 300 involves accessing a risk prediction model 120 trained to generate risk indicator values based on one or more similarity-preserving hashes, such as the first similarity-preserving hash, associated with a target entity. In some examples, the risk prediction model 120 may additionally or alternatively be or include one or more proprietary models (e.g., machine-learning models, etc.), one or more heuristics models, and/or one or more simulation models. The one or more similarity-preserving hashes can be generated based on data about the target entity interacting with a web page, user interface, and the like. As described in more detail with respect to FIG. 1 above, examples of entity data can include low-fidelity data, biometric data, and the like.

The risk indicator can indicate a level of risk associated with the entity, and the risk indicator can include indicators such as a credit score or fraud score of the target entity. In some examples, the one or more similarity-preserving hashes can be used to determine the risk indicator. For example, the risk prediction model 120 can compare the first similarity-preserving hash to a second similarity-preserving hash to determine the risk indicator. The second similarity-preserving hash may be or include a historical hash for an entity associated with data included in the query.

At block 306, the process 300 involves computing a risk indicator for the target entity based on the one or more similarity-preserving hashes using the risk prediction model 120. The one or more similarity-preserving hashes, or any suitable risk score determined or received therefrom, can be used as input to the risk prediction model 120. The one or more similarity-preserving hashes associated with the target entity can be generated based on data about the target entity and by one-way encrypting the data to generate the one or more similarity-preserving hashes. The output of the risk prediction model 120 can include the risk indicator for the target entity.

At block 308, the process 300 involves transmitting a responsive message based on the risk indicator (e.g., determined at block 306). In some examples, the risk assessment server 118 (or any other suitable module, model, or computing device) can transmit the responsive message to a computing device (e.g., the client computing system 104) or any other suitable computing device that can control access to the interactive computing environment 107. The responsive message can vary based on the risk indicator. For example, the responsive message may indicate that the target entity submitting the access request is the legitimate entity and may recommend granting access to the interactive computing environment 107 based on the request. In other examples, the responsive message may indicate that the entity is unknown or otherwise not associated with legitimate activity and may recommend challenging or denying the request.

In some examples, the responsive message may be generated and transmitted based on the comparison between the first similarity-preserving hash and the second similarity-preserving hash. For example, the risk prediction model 120 can generate one or more risk indicators for the target entity based on the comparison, and the risk assessment server 118 can generate the responsive message based on the one or more risk indicators. The one or more risk indicators can include a credit score, a fraud score, an identity score, other suitable scores indicating risk in one or more multiple dimensions associated with the target entity, or any suitable combination thereof, based on the comparison. The risk prediction model 120 can generate the risk indicator based on the feature vectors associated with the first similarity-preserving hash and the second similarity-preserving hash, can generate the risk indicator based on the comparison, and the like. The risk assessment server 118 can determine, based on the one or more risk indicators generated by the risk prediction model 120, whether to recommend granting, challenging, or denying the request submitted by the target entity. In some examples, the risk assessment computing system 130 can generate and transmit the responsive message to grant, challenge, or deny the request based on a recommendation provided by the risk prediction model 120.

### Data Flow for Generating Similarity-Preserving Hashes

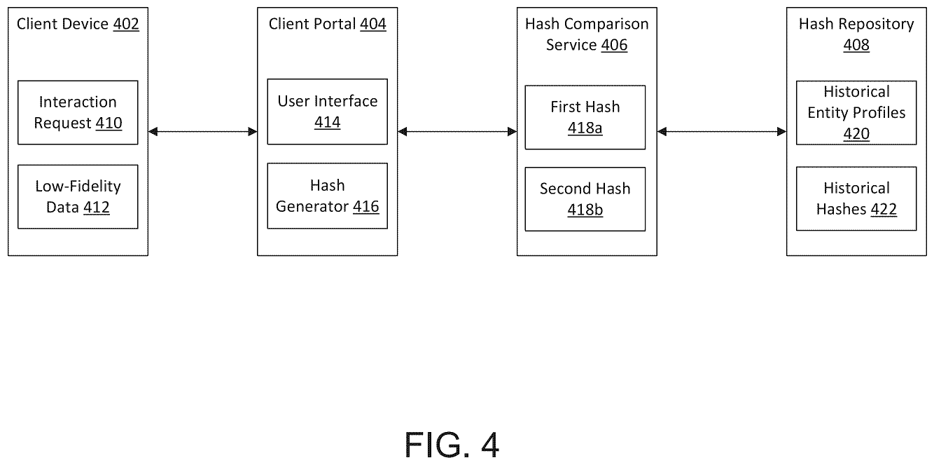

FIG. 4 is a block diagram illustrating a data flow for controlling access to an interactive computing environment using similarity hashing according to certain aspects of the present disclosure. As illustrated in FIG. 4, a client device 402 may be communicatively coupled with a client portal 404, which may be communicatively coupled with a hash comparison service 406, which may be communicatively coupled with a hash repository 408. In some examples, the client device 402 may be or be included in the user computing systems 106, the client portal may be or be included in the client computing systems 104, the hash comparison service 406 may be or be included in the risk prediction model 120, and the hash repository 408 may be similar or identical to the entity data repository 123a, the hash repository 123b, or a combination thereof.

The client device 402 may be used by a target entity. For example, the client device 402 may allow the target entity to generate an interaction request 410, and the client device 402 may collect low-fidelity data 412 about the target entity. The interaction request 410 may include a request to access an interactive computing environment such as the interactive computing environment 107. The low-fidelity data 412 may include non-identifying biometric data of the target entity, cursor movements of the target entity, screen orientations of the client device 402 used by the target entity, time spent on a webpage (e.g., a user interface 414) by the target entity, sensor measurements by the client device 402, and the like. The client device 402 may additionally provide the user interface 414 to the target entity to allow the target entity to provide authentication information, information about the interaction request 410, and the like. In response to receiving input from the target entity, the client device 402 may aggregate, transmit, or a combination thereof the interaction request 410 and the low-fidelity data 412 for transmitting the interaction request 410 and the low-fidelity data 412 to the client portal 404. In some examples, the client device 402 may use the user interface 414 provided by the client portal 404 to transmit the interaction request 410 and the low-fidelity data 412 to the client portal 404.

The client portal 404 may receive the interaction request 410 and the low-fidelity data 412. In other examples, the client portal 404, for example via the user interface 414, can gather the low-fidelity data 412 about the target entity, can directly receive the interaction request 410, and the like. The client portal 404 may include a hash generator 416, which may be configured to generate one or more similarity-preserving hashes based on data about the target entity. For example, the client portal 404 can execute the hash generator 416 to one-way encrypt the low-fidelity data 412 and any other suitable information about the target entity. The one-way encrypted data about the target entity may be or include a feature vector that is or is included in the one or more similarity-preserving hashes. The client portal 404 may transmit the one or more similarity-preserving hashes to the hash comparison service 406. In some examples, the client portal 404 may partially, or not at all, execute the hash generator 416 and may transmit the interaction request 410 and the low-fidelity data 412 associated with the target entity to a separate computing system, such as the risk assessment computing system 130, the hash comparison service 406, or the like, for generating the one or more similarity-preserving hashes.

The hash comparison service 406 may receive the one or more similarity-preserving hashes. For example, the hash comparison service 406 may receive a first hash 418a and a second hash 418b, which both or each may be similarity-preserving hashes. In some examples, the first hash 418a may be the first similarity-preserving hash generated based on real-time data gathered about the target entity, and the second hash 418b may be the second similarity-preserving hash that is a historical hash about an entity associated with data included in the interaction request 410. In some examples, the hash comparison service 406 can access the hash repository 408 to generate the second hash 418b (e.g., based on data retrieved from historical entity profiles 420) or to retrieve the second hash 418b (e.g., from historical hashes 422). While illustrated and described as including or using two hashes, the hash comparison service 406 can include or use other suitable numbers (e.g., less than two or more than two) of hashes.

The hash comparison service 406 can compare the first hash 418a and the second hash 418b to determine a likelihood that the interaction request 410 is legitimate. For example, the hash comparison service 406 can determine a similarity score between the first hash 418a and the second hash 418b, for example without needing to analyze raw data used to generate the first hash 418a or the second hash 418b. The hash comparison service 406 can apply a threshold value to the likelihood, to the similarity score, or the like to determine whether the target entity is likely to be a legitimate entity, whether the interaction request 410 is likely to be a legitimate request to access the interactive computing environment, or the like. In response to determining that the target entity is likely to be a legitimate entity, that the interaction request 410 is likely to be a legitimate request to access the interactive computing environment, or the like, the hash comparison service 406 may generate, or cause to be generated, a message responsive to the interaction request 410 to recommend initiating an interaction indicated by the interaction request 410. In response to determining that the target entity is likely to not be a legitimate entity, that the interaction request 410 is likely to not be a legitimate request to access the interactive computing environment, or the like, the hash comparison service 406 may generate, or cause to be generated, a message responsive to the interaction request 410 to recommend challenging or denying an interaction indicated by the interaction request 410.

### Example of Computing System

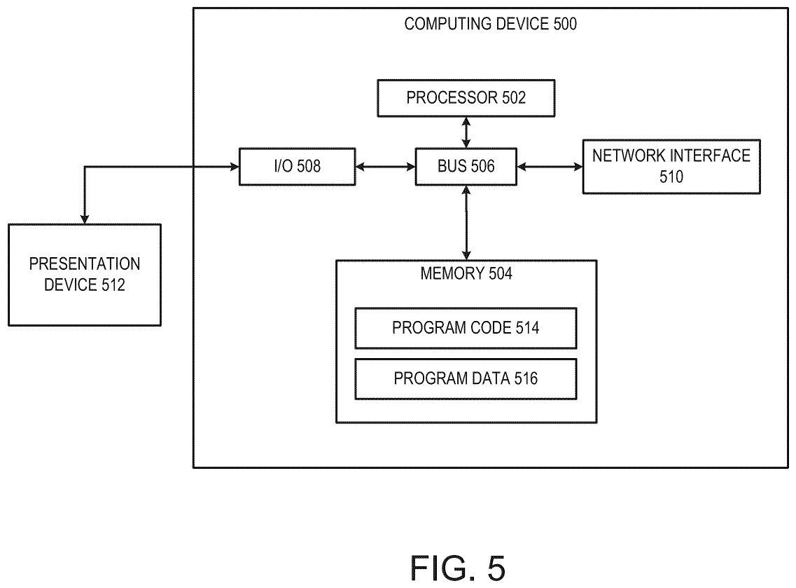

Any suitable computing system or group of computing systems can be used to perform the operations for the machine-learning operations described herein. For example, FIG. 5 is a block diagram depicting an example of a computing device 500, which can be used to implement the risk assessment server 118 or other suitable components of the computing environment 100. The computing device 500 can include various devices for communicating with other devices in the computing environment 100, as described with respect to FIG. 1. The computing device 500 can include various devices for performing one or more data consolidation or validation operations, or other suitable operations, described above with respect to FIGS. 1-4.

The computing device 500 can include a processor 502 that is communicatively coupled to a memory 504. The processor 502 can execute computer-executable program code stored in the memory 504, can access information stored in the memory 504, or both. Program code may include machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing or receiving information, data, arguments, parameters, or memory contents. Information, arguments, parameters, data, etc., may be passed, forwarded, or transmitted via any suitable means including memory sharing, message passing, token passing, network transmission, among others.

Examples of a processor 502 can include a microprocessor, an application-specific integrated circuit (ASIC), a field-programmable gate array (FPGA), or any other suitable processing device. The processor 502 can include any suitable number of processing devices, including one. The processor 502 can include or communicate with a memory 504. The memory 504 can store program code that, when executed by the processor 502, causes the processor 502 to perform the operations described herein.

The memory 504 can include any suitable non-transitory computer-readable medium. The computer-readable medium can include any electronic, optical, magnetic, or other storage device capable of providing a processor with computer-readable program code or other program code. Non-limiting examples of a computer-readable medium can include a magnetic disk, memory chip, optical storage, flash memory, storage class memory, ROM, RAM, an ASIC, magnetic storage, or any other medium from which a computer processor can read and execute program code. The program code may include processor-specific program code generated by a compiler or an interpreter from code written in any suitable computer-programming language. Examples of suitable programming language can include Hadoop, C, C++, C#, Visual Basic, Java, Python, Perl, JavaScript, ActionScript, etc.

The computing device 500 may also include a number of external or internal devices such as input or output devices. For example, the computing device 500 is illustrated with an input/output interface 508 that can receive input from input devices or provide output to output devices. A bus 506 can also be included in the computing device 500. The bus 506 can communicatively couple one or more components of the computing device 500.

The computing device 500 can execute program code 514 that can include the hash model 112. The program code 514 for the hash model 112 may be resident in any suitable computer-readable medium and may be executed on any suitable processing device. For example, as depicted in FIG. 5, the program code 514 for the hash model 112 can reside in the memory 504 at the computing device 500 along with the program data 516 associated with the program code 514. Executing the hash model 112 can configure the processor 502 to perform the operations described herein.

In some aspects, the computing device 500 can include one or more output devices. One example of an output device can be the network interface device 510 depicted in FIG. 5. A network interface device 510 can include any device or group of devices suitable for establishing a wired or wireless data connection to one or more data networks described herein. Non-limiting examples of the network interface device 510 can include an Ethernet network adapter, a modem, etc.

Another example of an output device can include the presentation device 512 depicted in FIG. 5. A presentation device 512 can include any device or group of devices suitable for providing visual, auditory, or other suitable sensory output. Non-limiting examples of the presentation device 512 can include a touchscreen, a monitor, a speaker, a separate mobile computing device, etc. In some aspects, the presentation device 512 can include a remote client-computing device that communicates with the computing device 500 using one or more data networks described herein. In other aspects, the presentation device 512 can be omitted.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

What is claimed is:

1. A system comprising:
a processor; and
a non-transitory computer-readable medium comprising instructions that are executable by the processor to cause the processor to perform operations comprising:
receiving, based on an interaction request submitted by a target entity, a first similarity-preserving hash, the interaction request comprising a request to access an interactive computing environment;
receiving a second similarity-preserving hash generatable based on entity data relating to an entity, the entity data comprising interaction data that indicates a manner in which the entity historically interacted with webpages;
determining, based on a comparison between the first similarity-preserving hash and the second similarity-preserving hash, a likelihood that the interaction request is legitimate; and
providing a responsive message based on a threshold relating to the likelihood, the responsive message usable to control access to the interactive computing environment.

2. The system of claim 1, wherein the first similarity-preserving hash comprises a first one-way encrypted feature vector, and wherein the second similarity-preserving hash comprises a second one-way encrypted feature vector.

3. The system of claim 2, wherein the operation of determining the likelihood that the interaction request is legitimate comprises:
determining a similarity score between the first one-way encrypted feature vector and the second one-way encrypted feature vector; and
determining, by comparing the similarity score to a threshold similarity score value, the likelihood that the interaction request is legitimate.

4. The system of claim 2, wherein the operation of determining the likelihood that the interaction request is legitimate comprises determining, based on a comparison between the first one-way encrypted feature vector and the second one-way encrypted feature vector, that the target entity is the entity.

5. The system of claim 1, wherein:
the operation of receiving the first similarity-preserving hash comprises generating the first similarity-preserving hash by using a randomized projections algorithm or a trend micro locality sensitive hash algorithm, wherein the first similarity-preserving hash is a one-way encrypted feature vector; and
the operation of receiving the second similarity-preserving hash comprises generating the second similarity-preserving hash by using a randomized projections algorithm or a trend micro locality sensitive hash algorithm, wherein the second similarity-preserving hash is a one-way encrypted feature vector.

6. The system of claim 1, wherein the interaction request comprises a first type of biometric data for the target entity, wherein the entity data comprises the first type of biometric data for the entity, wherein the first type of biometric data is not unique with respect to a respective entity, and wherein the operation of determining the likelihood that the interaction request is legitimate is performed without directly analyzing the first type of biometric data.

7. The system of claim 1, wherein the operation of providing the responsive message based on the comparison comprises one of:
initiating, in response to determining that the likelihood exceeds a threshold likelihood, an interaction based on the interaction request; or
challenging, in response to determining that the likelihood does not exceed the threshold likelihood, the interaction request.

8. A method comprising:
receiving, by a computing device and based on an interaction request submitted by a target entity, a first similarity-preserving hash, the interaction request comprising a request to access an interactive computing environment;
receiving, by the computing device, a second similarity-preserving hash generated based on entity data relating to an entity, the entity data comprising interaction data that indicates a manner in which the entity historically interacted with webpages;
determining, by the computing device and based on a comparison between the first similarity-preserving hash and the second similarity-preserving hash, a likelihood that the interaction request is legitimate; and
providing, by the computing device, a responsive message based on a threshold relating to the likelihood, the responsive message used to control access to the interactive computing environment.

9. The method of claim 8, wherein the first similarity-preserving hash comprises a first one-way encrypted feature vector, and wherein the second similarity-preserving hash comprises a second one-way encrypted feature vector.

10. The method of claim 9, wherein determining the likelihood that the interaction request is legitimate comprises:
determining a similarity score between the first one-way encrypted feature vector and the second one-way encrypted feature vector; and
determining, by comparing the similarity score to a threshold similarity score value, the likelihood that the interaction request is legitimate.

11. The method of claim 9, wherein determining the likelihood that the interaction request is legitimate comprises determining, based on a comparison between the first one-way encrypted feature vector and the second one-way encrypted feature vector, that the target entity is the entity.

12. The method of claim 8, wherein:
receiving the first similarity-preserving hash comprises generating the first similarity-preserving hash by using a randomized projections algorithm or a trend micro locality sensitive hash algorithm, wherein the first similarity-preserving hash is a one-way encrypted feature vector; and
receiving the second similarity-preserving hash comprises generating the second similarity-preserving hash by using a randomized projections algorithm or a trend micro locality sensitive hash algorithm, wherein the second similarity-preserving hash is a one-way encrypted feature vector.

13. The method of claim 8, wherein the interaction request comprises a first type of biometric data for the target entity, wherein the entity data comprises the first type of biometric data for the entity, wherein the first type of biometric data is not unique with respect to a respective entity, and wherein determining the likelihood that the interaction request is legitimate is performed without directly analyzing the first type of biometric data.

14. The method of claim 8, wherein providing the responsive message based on the comparison comprises one of:
initiating, in response to determining that the likelihood exceeds a threshold likelihood, an interaction based on the interaction request; or
challenging, in response to determining that the likelihood does not exceed the threshold likelihood, the interaction request.

15. A non-transitory computer-readable medium comprising instructions that are executable by a processing device for causing the processing device to perform operations comprising:
receiving, based on an interaction request submitted by a target entity, a first similarity-preserving hash, the interaction request comprising a request to access an interactive computing environment;
receiving a second similarity-preserving hash generatable based on entity data relating to an entity, the entity data comprising interaction data that indicates a manner in which the entity historically interacted with webpages;
determining, based on a comparison between the first similarity-preserving hash and the second similarity-preserving hash, a likelihood that the interaction request is legitimate; and
providing a responsive message based on a threshold relating to the likelihood, the responsive message usable to control access to the interactive computing environment.

16. The non-transitory computer-readable medium of claim 15, wherein the first similarity-preserving hash comprises a first one-way encrypted feature vector, wherein the second similarity-preserving hash comprises a second one-way encrypted feature vector, and wherein the operation of determining the likelihood that the interaction request is legitimate comprises:
determining a similarity score between the first one-way encrypted feature vector and the second one-way encrypted feature vector; and
determining, by comparing the similarity score to a threshold similarity score value, the likelihood that the interaction request is legitimate.

17. The non-transitory computer-readable medium of claim 16, wherein the operation of determining the likelihood that the interaction request is legitimate comprises determining, based on a comparison between the first one-way encrypted feature vector and the second one-way encrypted feature vector, that the target entity is the entity.

18. The non-transitory computer-readable medium of claim 15, wherein:
the operation of receiving the first similarity-preserving hash comprises generating the first similarity-preserving hash by using a randomized projections algorithm or a trend micro locality sensitive hash algorithm, wherein the first similarity-preserving hash is a one-way encrypted feature vector; and
the operation of receiving the second similarity-preserving hash comprises generating the second similarity-preserving hash by using a randomized projections algorithm or a trend micro locality sensitive hash algorithm, wherein the second similarity-preserving hash is a one-way encrypted feature vector.

19. The non-transitory computer-readable medium of claim 15, wherein the interaction request comprises a first type of biometric data for the target entity, wherein the entity data comprises the first type of biometric data for the entity, wherein the first type of biometric data is not unique with respect to a respective entity, and wherein the operation of determining the likelihood that the interaction request is legitimate is performed without directly analyzing the first type of biometric data.

20. The non-transitory computer-readable medium of claim 15, wherein the operation of providing the responsive message based on the comparison comprises one of:
initiating, in response to determining that the likelihood exceeds a threshold likelihood, an interaction based on the interaction request; or
challenging, in response to determining that the likelihood does not exceed the threshold likelihood, the interaction request.
